(19) United States
(12) Patent Application Publication
(10) Pub. No.: US 2004/0241610 A1
(43) Pub. Date: Dec. 2, 2004

(54) Dental implant system

(76) Inventor: Steve Hurson, Yorba Linda, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/748,869

(22) Filed: Dec. 30, 2003

Related U.S. Application Data
(60) Provisional application No. 60/438,266, filed on Jan. 3, 2003.

(51) Int. Cl. A61C 8/00

(52) U.S. Cl. 433/173

(57) ABSTRACT

A dental implant and abutment combination includes an implant body portion and an abutment portion. The implant body portion is located at a distal end of the combination and is configured to lie at least partially below a crest of a patient's jawbone. The abutment portion is located at a proximate end of the combination and is configured to lie at least partially above the crest of the patient's jawbone. The abutment portion comprises a flared portion, a shoulder portion and a final restoration portion. The shoulder portion lies between the flared portion and the final restoration portion.

This application claims the priority benefit under 35 U.S.C. § 119(e) of Provisional Application No. 60/438,266 filed Jan. 3, 2003, which is hereby incorporated by reference herein.

### BACKGROUND OF THE INVENTION

1 Field of the Invention

The present invention relates generally to dental implants and more particularly to dental implants systems.

2 Description of the Related Art

Implant dentistry involves the restoration of one or more teeth in a patient's mouth using artificial components. Such artificial components typically include a dental implant and a prosthetic tooth and/or a final abutment that is secured to the dental implant. The process for restoring a tooth may be carried out in three stages.

Stage I involves implanting the dental implant into the bone of a patient's jaw. The oral surgeon first accesses the patient's jawbone through the patient's gum tissue and removes any remains of the tooth to be replaced. Next, the specific site in the patient's jaw where the implant will be anchored is widened by drilling and/or reaming to accommodate the width of the dental implant to be implanted. Then, the dental implant is inserted into the hole in the jawbone, typically by screwing, although other techniques are known for introducing the implant in the jawbone.

The implant itself is typically fabricated from pure titanium or a titanium alloy. Such materials are known to produce osseointegration of the fixture with the patient's jawbone. The dental implant fixture also typically includes a hollow threaded bore through at least a portion of its body and extending out through its proximal end which is exposed through the crestal bone for receiving and supporting the final tooth prosthesis and/or various intermediate components or attachments.

After the implant is initially installed in the jawbone, a cover screw is secured over the exposed proximal end in order to seal the internal bore. The patient's gums are then sutured over the implant to allow the implant site to heal and to allow desired osseointegration to occur. Complete osseointegration typically takes anywhere from four to ten months.

During stage II, the surgeon reaccesses the implant fixture by making an incision through the patient's gum tissues. The cover screw is then removed, exposing the proximal end of the implant. The interior of the implant is thoroughly cleaned and dried. The surgeon then attaches a temporary healing abutment or a final abutment to the implant. Typically, the healing or final abutment includes a threaded post, which is screwed directly into the hollow threaded bore of the implant. To accurately record, the position the orientation and the shape of the final abutment, the surgeon may take a mold or impression of the patient's mouth. The impression is used to create a plaster model or analogue of the mouth and the abutment and provides the information needed to fabricate the prosthetic replacement tooth and any required intermediate prosthetic components. Stage II is typically completed by securing a protective cap to the abutment with temporary cement. Alternatively, a conventional temporary restoration may be attached to the abutment.

Stage III involves fabricating and placement of a cosmetic tooth prosthesis to the implant fixture. The plaster analogue provides laboratory technicians with a model of the patient's mouth and the final abutments. Based on this model, the technician constructs a final restoration. The final step in the restorative process is attaching the final restoration to the abutment.

### SUMMARY OF THE INVENTION

One embodiment of the invention includes the recognition that the body's natural defense mechanisms tend to provide approximately a 1-3 millimeter zone of soft tissue between the abutment-implant interface (i.e., microgap) and the alveolar crest. This zone is referred to as the “biological width” and is present around natural teeth as well as dental implants. The biological width typically extends 360 degrees around the implant and lies coronal to the alveolar crest and apical to the prosthetic crown margin (approximately 2.5-3 millimeters). The biological width consists of approximately 1 millimeter gingival sulcus, 1 millimeter epithelial attachment and 1 millimeter connective tissue zone. In prior art implants, the abutment-implant interface typically lies flush with the alveolar crest. As such, the bone tissue is reabsorbed and the alveolar crest retreats until the proper biological width may be reestablished. This bone loss is undesirable both aesthetically and structurally.

Accordingly, in one embodiment, a one-piece dental implant includes an implant body portion and an abutment portion. The implant body portion is located at a distal end of the combination and is configured to lie at least partially below a crest of a patient's jawbone. The abutment portion is located at a proximate end of the combination and is configured to lie at least partially above the crest of the patient's jawbone. The abutment portion comprises a flared portion, a shoulder portion and a final restoration portion. The shoulder portion lies between the flared portion and the final restoration portion.

All of these embodiments are intended to be within the scope of the invention herein disclosed. These and other embodiments of the present invention will become readily apparent to those skilled in the art from the following detailed description of the preferred embodiments having reference to the attached FIGS., the invention not being limited to any particular preferred embodiment(s) disclosed.

Brief Description of the Drawings

These and other features of the invention will now be described with reference to the drawings of the preferred embodiments, which are intended to illustrate and not to limit the invention, and in which:

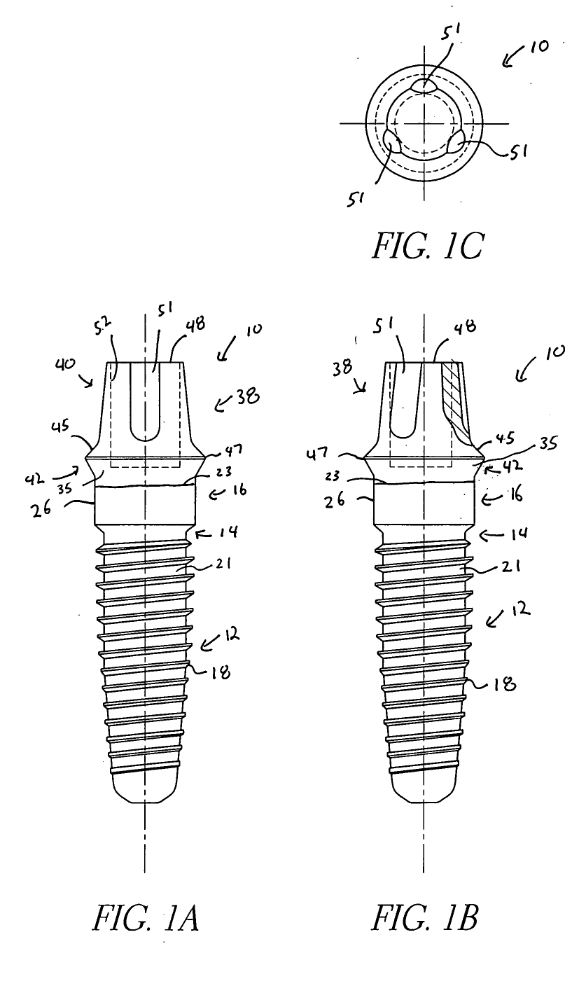

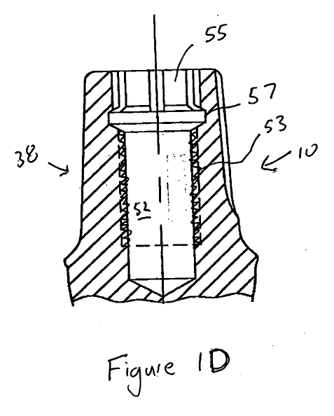

FIG. 1A is a front view of an exemplary embodiment of a dental implant;

FIG. 1B is a side view of the dental implant of FIG. 1A;

FIG. 1C is a top view of the dental implant of FIG. 1A;

FIG. 1D is a cross-sectional view of an upper portion of the dental implant of FIG. 1A;

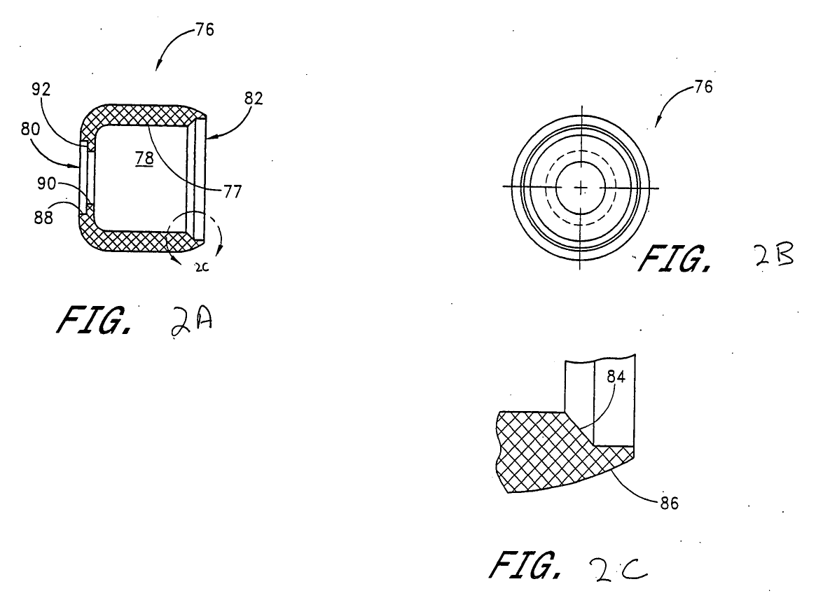

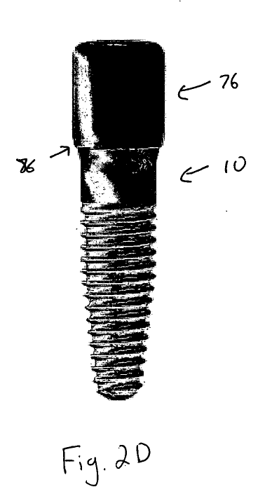

FIG. 2A is a cross-sectional view of an exemplary embodiment of a healing cap;

FIG. 2B is a bottom plan view the healing cap of FIG. 2A;

FIG. 2C is a is a closer view of a section of the healing cap of FIG. 2A;

FIG. 2D is a side view showing the healing cap of FIG. 2A positioned on the dental implant of FIG. 1A;

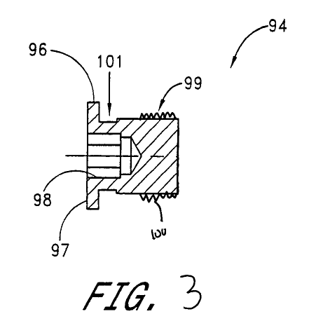

FIG. 3 is a cross-sectional side view of an exemplary embodiment of a healing cap screw;

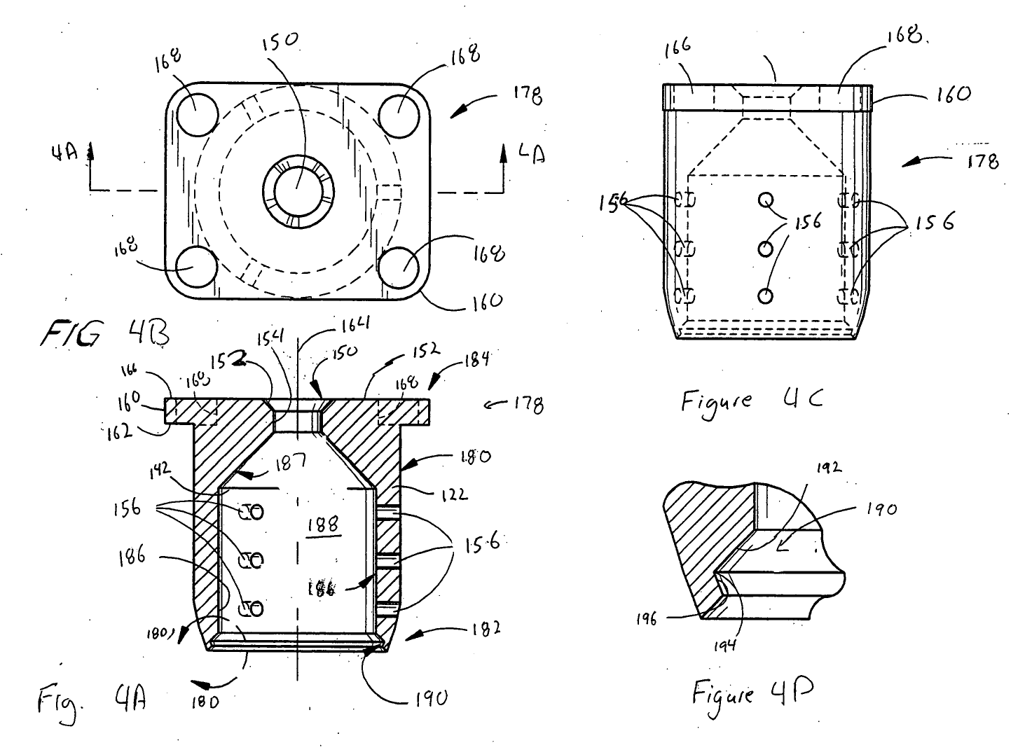

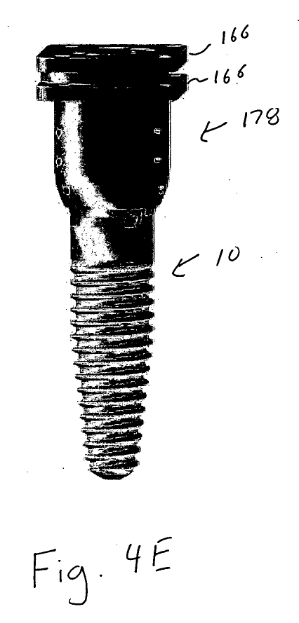

FIG. 4A is a cross-sectional side view of an exemplary embodiment of an impression cap, which may be used with the dental implant of FIG. 1A;

FIG. 4B is a top plan view of the impression cap of FIG. 4A;

FIG. 4C is a side elevational view of the impression cap of FIG. 4A;

FIG. 4D is a close up view of a portion of FIG. 4A; and

FIG. 4E is a side elevation view of the impression cap of FIG. 4A attached to the dental implant of FIG. 1A;

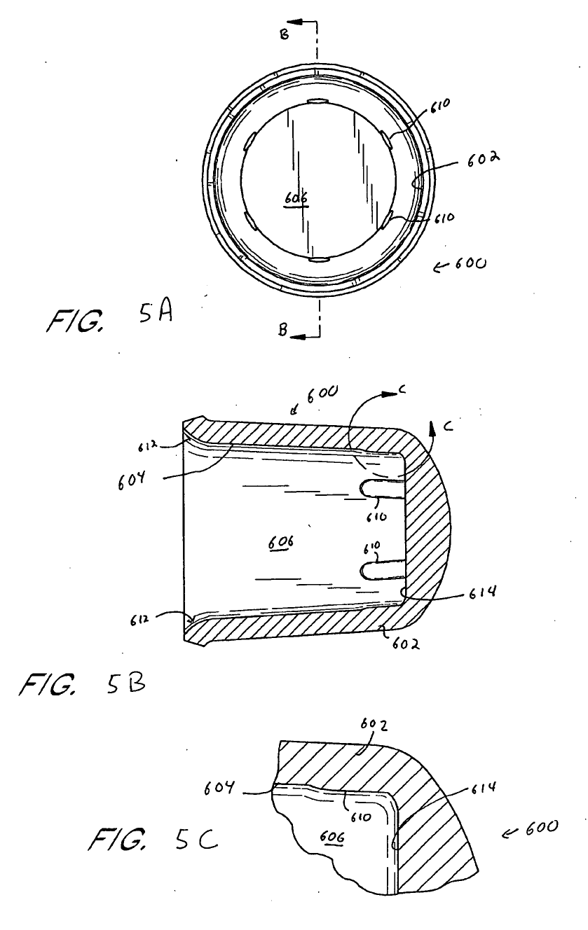

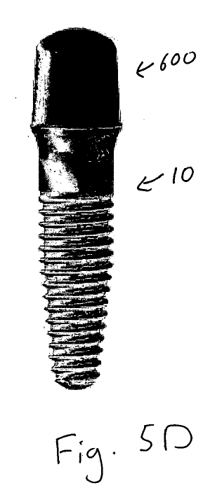

FIG. 5A is a bottom plan view of an exemplary embodiment of a coping that may be used with the dental implant of FIG.1 A;

FIG. 5B is a cross-sectional view taken along line B-B of FIG. 5A;

FIG. 5C is a cross-sectional view taken along line C-C of FIG. 5A;

FIG. 5D is a side elevational view of the coping of FIGS. 5A-C placed over the dental implant of FIG. 1A;

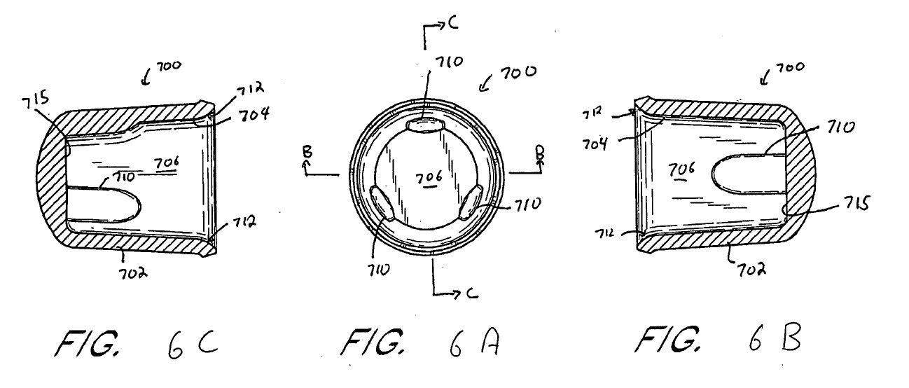

FIG. 6A is a bottom plan view of another exemplary embodiment of a coping that may be used with the dental implant of FIG. 1A;

FIG. 6B is a cross-sectional view taken along line B-B of FIG. 6A;

FIG. 6C is a cross-sectional view taken along line C-C of FIG. 6A;

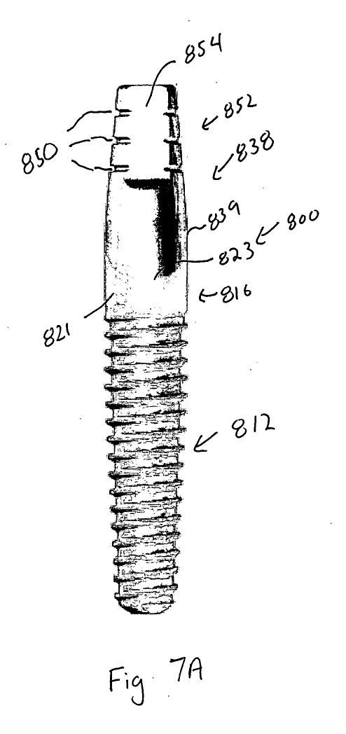

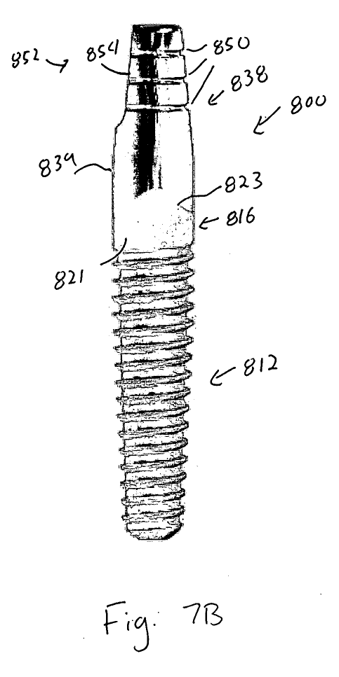

FIG. 7A front view of another exemplary embodiment of a dental implant;

FIG. 7B is a side view of the dental implant of FIG. 7A;

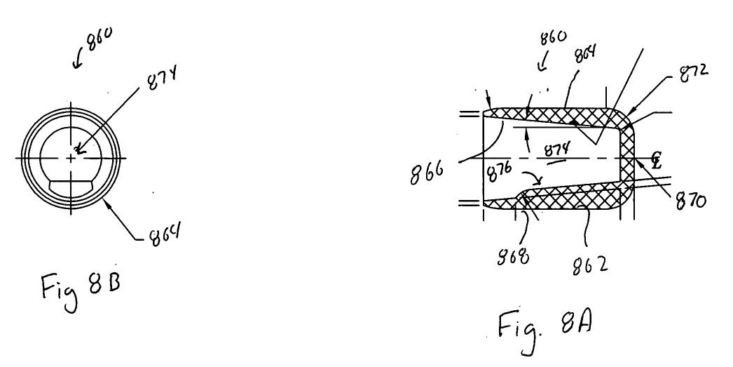

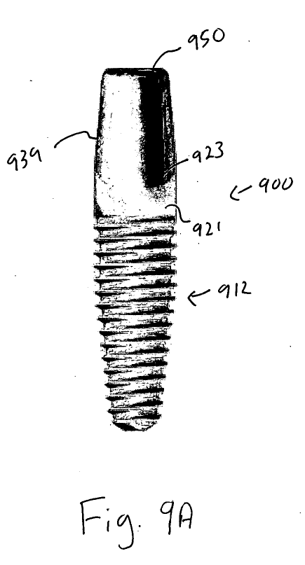

FIG. 8A is a cross-sectional view of an exemplary embodiment of a healing cap that may be used with the dental implant of FIG. 7A;

FIG. 8B is a bottom view of the healing of FIG. 8A;

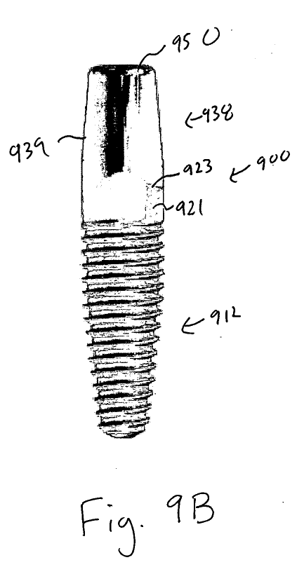

FIG. 9A front view of another exemplary embodiment of a dental implant; and

FIG. 9B is a side view of the dental implant of FIG. 8A.

### DETAILED DESCRIPTION OF THE PREFERRED EMBODIMENTS

FIGS. 1A-1C illustrate an exemplary embodiment of single stage dental implant 10. As is known in the art, with a single stage implant, stage I and stage II surgery may be combined into a single procedure. The implant 10 is preferably sized and dimensioned to receive and support one or more dental attachments or components, which will be described in detail below. In particular, the dental implant 10 is sized and dimensioned to support a final restoration. The implant 10 is preferably made of a dental grade titanium alloy, although other suitable materials may also be used.

As best seen in FIG. 1A, the implant 10 includes a body portion 12, a neck 14, and a collar 16. The body portion 12 is preferably generally cylindrical with a tapered distal end and includes threads 18 that may be configured to mate with a preformed threaded hole or osteotomy formed in the patient's jawbone (not shown). However, it should be appreciated that the body portion 12 may also be configured so as to be self-tapping. It should also be appreciated that although the illustrated body portion 12 has tapered or conical portions, the body portion 12 may be substantially cylindrical or completely tapered. Finally, it should be appreciated that the body portion 12 may be unthreaded if the surgeon prefers to use an unthreaded implant. In one particular embodiment, the body 12 has a shape substantially similar to the Branemark System® line of implants sold by Nobel Biocare™. In such an embodiment, the lower portion may be substantially. cylindrical, including threads, and self-tapping features as is well known in the art.

The collar 16 of the implant is substantially cylindrical and is defined in part by a vertical side wall 26 that, in the preferred embodiment, is approximately 2 millimeters in axial length. In modified embodiments, the implant 10 may be formed without the neck 14 and/or the collar 16. Similarly, the neck 14 and/or collar 16 may have dimensions that are smaller or larger than the exemplary embodiment.

In the illustrated embodiment, the body 12 is preferably covered with a bone apposition surface 21, which is configured to promote osseointegration. In one embodiment, the bone apposition surface 21 increases the surface area of the body 12. In such an embodiment, to increase surface, the bone apposition surface 21 may be formed by roughening the lower portion 12 in several different manners, such as, for example, acid-etching (e.g., to apply an oxidized titanium surface such as the oxidized surface manufactured by Nobel Biocare under the trademark TiUnite™), grit blasting, and/or machining. Alternatively, the bone apposition surface 21 may be formed by coating the lower surface with a substance that increases the surface area of the body 21. Calcium phosphate ceramics, such as tricalcium phosphate (TCP) and hydroxyapatite (HA) are examples of suitable materials. In other embodiments, the bone apposition surface 21 may comprise macroscopic structures, such as, for example, threads, micro-threads, indentations, grooves that are configured to promote osseointegration and may be used alone or combined with the roughening and/or the coatings described above.

With continued reference to FIGS. 1A and 1B, in the exemplary embodiment, a top edge 23 of the bone tissue apposition surface 21 preferably extends above through the neck 14 and onto the collar 16. In modified embodiments, the top edge 34 may have a curved or scalloped shape with at least one and more preferably two peaks and valleys that follow or at least closely approximate the shape of the naturally occurring contours of a patient's bone-tissue morphology. It should also be appreciated that in other embodiments, the peaks and valleys may be approximated by various combinations of straight and/or curved lines that follow or at least closely approximate the shape of the naturally occurring contours of a patient's bone-tissue morphology.

The surface 35 of the collar 16 above the top edge 23 may be polished to reduce accumulation of plaque and calculus. In a modified embodiment, the surface 35 may be treated to promote, enhance or maintain soft-tissue attachment. Such treatments may include applying growth factor, applying protein, roughening and/or the application of coatings that increase surface area. In addition, the surface 35 may be modified or covered with a coating that changes the color of the collar 16. For example, in one embodiment the surface 35 is coated with a material hydroxyapatite (HA) or other ceramic coatings that are generally white or “tooth-like” in color.

With continued reference to FIGS. 1A-C, exemplary implant 10 includes an upper portion or abutment 38, which is integrally formed with or permanently attached to the collar 16. In this manner, there is preferably no “microgap” between the abutment 38 and the collar 16. In a preferred embodiment, the body 12, collar 16 and the abutment 38 are machined from a single piece of material (e.g., dental grade alloy). As will be explained in more detail below, the abutment 38 is sized and dimensioned to support a final restoration and other dental components.

As best seen in FIGS. 1A and 1B, the outer surface of the final abutment 38 preferably includes an upper region 40 and a flared region 42. In the illustrated embodiment, the upper region 40 is substantially smooth and tapered. The upper region 40 also has a top surface 48 that is substantially flat. Towards the bottom of the upper region (i.e., the portion nearest the flared region 42) is a flared portion 45 that flares outward towards a shoulder or ridge 47. The flared region 42 extends from the ridge 47 and connects the upper region 40 to vertical side wall 26 of the collar 16.

In the illustrated embodiment, the upper region 40 also preferably includes a plurality of grooves 51 (see also FIG. 1C). These grooves 51 help orient and prevent the rotation of a final restoration as described below. Accordingly, the final restoration may have an inner surface that matches or engages the shape of the upper region 40 of the abutment 38. However, those skilled in the art will readily appreciate that the upper region 40 and the grooves 51 may be formed into a variety of other shapes that may also provide an anti-rotational interface between the final restoration 54 and the abutment 38.

In general, the illustrated dental implant 10 has a generally circular cross-sectional shape. However, it should be appreciated that in modified embodiments the cross-sections may be non-round. For example, the cross-section of the upper region and flared region may have a non-round (e.g., oval) cross-section that resembles the cross-section of a natural tooth.

To permanently secure the final restoration, cement may be applied to the upper region 40 of the abutment 38. Alternatively, the final restoration 52 may be coupled to the final abutment 38 by a screw (not shown). In such an arrangement, a screw hole (not shown) may be provided on the side of the abutment 38.

As best seen in FIG. 1D, the abutment 38 advantageously includes an inner bore 52 that may include a threaded portion 53. As will be explained in more detail below, the inner bore 52 is configured to receive a coupling screw, which may be used to couple various components to the implant 10. The inner bore 52 may also include an anti-rotation chamber 55, which includes one or more anti-rotation features, such as, for example, flat sides, grooves, and/or indentations. A driving tool (not shown) with corresponding anti-rotational features may be inserted into the anti-rotational chamber so as to transmit torque from the driving tool to the dental implant 10 and or prevent rotation between the implant 10 and a mating component (e.g., a healing cap, impression coping or dental restoration). In one embodiment, the anti-rotation chamber 55 may comprise a hexagonal recess configured to receive a hexagonally shaped tool such as a conventional Allen ® wrench. In another embodiment, the chamber 55 may include a tapered recess comprising plurality of concave side portions interconnected by flat or slightly curved side portions (see e.g., the internal connection marketed under the trademark Unigrip™ by Nobel Biocare AB).

The illustrated inner bore 52 may also include an annular recess or notch 57. The notch 57 may be configured for receiving the prongs or snapping elements on a mating component or driver. In this manner, the driver or mating component may be releaseably engaged with the implant 10. Any of a variety of complementary surface structures may be provided, to create a releasable retention force between the system and the mating component or driver. For example, the mating component or driver may include one or more lever arms or prongs that cooperate with the notch 57. In other embodiments, the driver or mating component may include a band of resilient material configured to produce a friction or mechanical interference fit retention force. In the illustrated embodiment, the releasable retention force is added by providing the notch 57. However, in modified embodiments, the complementary surface structures may be configured to engage a bore 52 without a notch 57.

FIGS. 2A-2D illustrate an exemplary embodiment of a healing cap 76 that may be used in combination with the dental implant 10 described above. The healing cap 76 may be made of a synthetic polymer, such as, for example, polyester or Nylon. However, it should be appreciated that other suitable materials may also be used. The healing cap 76 is preferably white or close to natural tooth color so that it has a natural appearance when it is placed in the patient's mouth.

The healing cap 76 includes an inner surface 77 which defines an internal cavity 78. The inner surface 77 also defines a top opening 80 and a bottom opening 82. The inner surface 77 is sized and dimensioned such that the that healing cap fits over the upper region 40 of the abutment 38. With particular reference to FIG. 2C, the inner surface 77 preferably includes a stop for limiting advance of the healing cap 76 onto the abutment 38, such as, a base surface 84 that is sized and dimensioned to rest against the flanged portion 45 of the final abutment 38.

With continued reference to FIG. 2C, the healing cap 76 also preferably includes a tissue retraction flange 86. The tissue retraction flange 86 is sized and dimensioned such that when the healing cap 76 is placed upon the abutment 38 it extends beyond at least the upper limit of the shoulder 47 of the abutment 38. The purpose and function of the tissue retraction flange 86 will be described below.

With reference to FIG. 2B, the top opening 80 is preferably defined by top and bottom portions 88, 90. The diameter of the top portion 88 is slightly larger than the diameter of the second portion 90. Accordingly, a seat 92 is formed between the first and second portions 88, 90. The seat 92 provides support for a healing cap screw 94 (see FIG. 3). Alternatively, and/or in addition, the opening 80 may be flared or chamfered to provide a flared seating surface.

As with the abutment 38, it should be appreciated that although the illustrated cross-sections of the healing cap 76 are round in modified arrangements the cross-sections may be non-round. For example, the cross-sections may have a non-round cross-section that resembles the cross-section of a natural tooth.

Turning now to FIG. 3, the healing cap screw 94 will now be described. The healing cap screw 94 is sized and dimensioned so as extend through the healing cap 76 and to couple the healing cap 76 to final abutment 38. The healing cap screw 94 is preferably made of a dental grade titanium alloy; although, other suitable materials may be used. The healing cap screw 94 includes a flange 96, an anti-rotational recess 98, a barrel 99 and lower threads 100. The flange 96 preferably has a diameter that is slightly smaller than the diameter of the upper portion 88 of the healing cap 76. The recess 98 extends through the flange 96 and allows for the insertion of, for example, hexagonally shaped tool such as a conventional Allen® wrench or the tools sold under the trademark Unigrip™ by Nobel Biocare AB, which may be used to rotate the healing cap screw 94. The threads 100 are sized and dimensioned to match the threaded bore 52 of the implant 10 (see FIG. 1D).

Preferably, the barrel 99 has a diameter that is slightly larger than the inner diameter of the bottom portion of the healing cap 76. The barrel 99 preferably includes a groove 101, which is located below the flange 96 and has a diameter that is slightly smaller than the inner diameter of the bottom portion 90 of the healing cap. As such, the healing cap screw 94 may be press-fit into the healing cap 76 such that the bottom portion 90 fits into the groove 101 and the top portion 97 is flush with the top of the healing cap 76. In this manner, the healing screw 94 is captured by the healing cap 76 and may rotate freely inside the healing cap 76. Of course, in a modified arrangement, the healing cap screw 94 may be configured without the capture feature.

In use, the surgeon first places the implant 10 into the patient's jawbone during Stage I surgery with the top edge 23 of the bone apposition surface being approximately equal or slightly above the upper most bone surface. The surgeon then places the healing cap 76 over the abutment 38 and uses the captured healing cap screw 94 to couple the healing cap 76 to the abutment 38. Specifically, the surgeon rotates the healing cap screw 94 so that the threads 100 engage the inner bore 52 of the implant 10. Accordingly, the healing cap 76 is held securely against the abutment 38. As will be explained in more detail below, the healing cap 76 helps to control the healing and growth of the patient's gum tissue around the implant site. The healing cap 76 also improves the appearance of the patient's mouth and provides the patient with a temporary chewing surface. If desired, the healing cap 76 may also be used to support a temporary restoration and/or may itself be shaped in the form of a temporary restoration.

The patient then returns home and the implant is allowed to osseointegrate with the jawbone and the patient's gums are allowed to heal. Once the implant osseointegrates and the gums heal, the patient returns to the surgeon who takes an impression of the patient's mouth. The surgeon loosens the healing cap screw 94 and removes the healing cap 76 from the final abutment 38. As will be described in more detail below, at this point, the surgeon takes the impression of the patient's mouth to record the position, orientation and shape of the dental abutment within the mouth.

As will be described below, the impression is used to make a model of the patient's mouth and to form the final restoration. As mentioned above, the final restoration has an inner surface that matches the upper region 40 of the abutment 38. Accordingly, in a final procedure, the surgeon may attach the final restoration by slipping it onto the final abutment 38 cementing it in place and/or securing it with a screw.

As best seen in FIG. 2D, the tissue retraction flange 86 controls the healing and growth of the patient's gum tissue around the abutment 38. In contrast, prior art protection caps would rests upon the shoulder region if the abutment. This allows the gum tissue during a healing period grows near and above the shoulder region during healing periods. This may cause several problems. For example, when such a protection cap is removed, the gum tissue tends to relax and fall over the shoulder region. When an impression is taken of the abutment, this fallen gum tissue may compromise the accuracy of the impression. Moreover, if an impression cap such as the one disclosed in U.S. Pat. No. 5,688,123 is used, the fallen gum tissue may become pinched between the impression cap and the shoulder region when the impression cap is snapped over the shoulder region. This may cause discomfort to the patient. In addition, when a final restoration is attached to the final abutment and implant, the gum tissue may also become pinched in between the final restoration and the shoulder region.

In contrast, in the illustrated embodiment of the healing cap 76 includes a tissue retraction flange 86 that extends below the shoulder 47 of the final abutment 38. The tissue retraction flange 86 pushes the gum tissue down and away from the shoulder 47. The tissue retraction flange 86 also pushes the gum tissue laterally away from the shoulder 47. Accordingly, a gap is formed between the gum tissue and the shoulder 47 of the final abutment 38. Thus, when the healing cap 76 is removed, the gum tissue is less likely to fall over the shoulder 47. This arrangement tends to prevent patient's gums from falling over the shoulder 47 of the abutment when (i) the impression is taken, (ii) an impression cap is being attached to the abutment and/or when the final restoration is attached to the abutment 38. This results in more accurate impressions and minimal discomfort to the patient.

The tissue retraction flange 86 is sized and dimensioned to hold the gum tissue far enough away from the shoulder 47 to achieve some or all the results described above. Generally, the tissue retraction flange 86 holds the gum tissue at least about 0.25 millimeters below the shoulder, in some embodiments about 0.5 millimeters, in other embodiments 1 millimeter or greater. Additional embodiments and more details concerning the healing cap 76 may be found in U.S. Pat. No. 6,431,866, entitled “HEAL IN-PLACE ABUTMENT SYSTEM”, issued Aug. 13, 2002 and hereby incorporated by reference in its entirety herein.

FIGS. 4A-E illustrate an impression cap 174, which may be used to take an impression of the dental implant 10 as mentioned above. In this exemplary embodiment, the impression cap 174 is configured to engage the dental implant 10 with a releasable retention force. The illustrated impression cap 178 comprises a body 180 with a proximal end 182 and a distal end 184. The body 122 is preferably made of resilient moldable plastic and/or polymer, such as, for example, polycarbonate. The body 180 defines an inner surface 186, which forms an inner cavity 188. The inner cavity 188 is configured such that the impression cap 178 may fit over the upper region 40 of the abutment 38.

In the illustrated embodiment, the impression cap 178 is preferably configured to engage the abutment 38 of the implant 10 in a snap fit. In the illustrated embodiment, this snap fit is achieved by providing the proximal end 182 with a notch or groove 190, which is best seen in FIG. 4D. The groove 190 is configured to snap over the shoulder 47 of the abutment 38. That is, in the engaged position, the groove 190 fits around the shoulder 47 of the abutment 38 such that the impression cap 178 is coupled to the abutment 38. In the illustrated embodiment, the groove 190 is generally V-shaped with an distal portion 192, an apex 194 and a proximal portion 196. In the engaged position, the proximal portion 196 lies generally below the shoulder 47 of the abutment 38, the apex 136 lies generally parallel to the shoulder 47 and the distal portion 192 lies generally above the shoulder 47. Advantageously, in the illustrated embodiment, the distal portion 192 is oriented such that it may lie flush with the flared portion 45 of the abutment 152. The distal portion 192 preferably blends into the radius of the apex 194. In one embodiment, the apex 194 has a radius of about 0.004″ to 0.002″ and, in a preferred embodiment, the apex has a radius of about 0.003″.

Preferably, the groove 190 is sized and dimensioned such that in the engaged position the impression cap 178 may be rotated with respect to the final abutment 158. That is, in a preferred embodiment, the space defined by the groove 192 is slightly larger than the corresponding portions of the flared portion 45, the shoulder 47 and the notch 172 of the final abutment 152. As such, in the engaged position, the proximal portion 196 of the impression cap 178 is not in a stressed (e.g., in a flexed and/or compressed state). Of course, in one modified embodiment, the groove 192 may be sized and dimensioned such that in the engaged position the proximal portion is stressed and thus exerts a positive holding force on the final abutment 152.

With reference back to FIG. 4A, in the illustrated embodiment, the side wall 186 extends from the proximal portion to a roof 187. Preferably, a junction 142 between the side wall 186 and the roof 187 is located at about the same elevation as the top surface of the abutment 38 when the impression cap 178 is in an engaged position. In the illustrated embodiment, the side wall 186 is substantially smooth and has a substantially cylindrical shape. However, in modified embodiments, the side wall 186 may be textured or roughened so as to enhance retention of impression material, which, as will be explained below, is injected into the cavity 188. The substantially cylindrical shape of the side wall 186 is generally preferred because it provides a large amount of space for the impression material near the top surface of the abutment 38, which as will be explained below may be modified by the dental surgeon. Correspondingly, it provides also provides less space for the impression material near the shoulder 47 of the abutment 38. This arrangement therefore creates a thin or featheredge of impression material which fades away at the shoulder 47 of the abutment 38.

In the illustrated embodiment, the roof 187 is funnel shaped. That is, the roof 187 tapers from the most distal end 184 to the side walls 186. Advantageously, the roof 187 defines a transition space, which is located above the top surface of the abutment 38 when the impression cap 120 is in the engaged position. The transition space facilitates the flow of impression material above the abutment 38 to the sides and shoulder 47 of the abutment 38.

With particular reference to FIG. 4A, the impression cap 178 also includes an injection port 150, which provides a pathway for injecting impression material into the internal cavity 188. In the illustrated embodiment, the injection port 150 is positioned at the distal end 184 on a top surface 152 of the impression cap 120 and communicates with the transition space. The illustrated injection port 150 includes a tapered portion 152 and a cylindrical portion 154. The cylindrical portion 154 preferably has a diameter that is approximately equal to a gap between the top of the abutment 38 and the side wall 186, when the impression cap 178 is engaged on the implant 10. This arrangement is preferred because it ensures that impression material injected into the impression cap is directed towards space between the side of the abutment 38 and the side wall 186. In one embodiment, the cylindrical portion has a diameter of about 0.06 inches and the most distal portion of the tapered section 152 has a diameter of about 0.09.

As best seen in FIGS. 4A and 4C, the impression cap 178 includes a plurality of vent holes 156, which extend through the main body 122 into the cavity 188. In the illustrated embodiment, the vent holes 156 are arranged in three rows. Each row comprises three vent holes 156, which are aligned vertically. The rows are spaced about 120 degrees apart around the periphery of the impression cap 178. As will be explained in detail below, the vent holes 156 provide a vent for air and excess impression material. In one embodiment, the vent holes 156 have a diameter of about 0.2 inches. In the illustrated embodiment, the vent holes 156 are generally cylindrical but in modified embodiments may be funneled shaped with the end exposed to the inner cavity 188 having a smaller diameter than the other end.

With reference back to FIG. 4A, the impression cap 178 preferably includes one ore more embedment features 160. As will be explained in more detail below, the embedment features 160 facilitate the gripping and retention of the impression cap 178 within an impression tray. The one or more embedment features preferably define at least one interference surface 162, which faces lies generally transverse to a longitudinal axis 164 of the impression cap. In the illustrated embodiment, the embedment feature 160 comprises a flange 166, which is positioned the distal end 184 of the main body 122. The illustrated flange 166 includes a plurality of through holes 168, which extends through the four corners of the flange 166. In one embodiment, each hole 168 preferably has a diameter of about 0.050″. In FIG. 4E, the impression cap 178 includes a pair of flanges 166.

In use, the impression cap 178 may be used to take an impression of the abutment 38 and/or record the orientation of the implant 10. Such an impression may be taken during stage one, two or stage three as deemed effective by the dental practitioner. In some embodiments, a block out plug (not shown) may be first inserted into the bore 52 of the abutment 38 to prevent impression material from entering the bore 52.

After the block out plug is in place, the surgeon then snaps the impression cap 178 onto the abutment 38 as shown in FIG. 4E. After the impression cap 178 is in place, the surgeon uses a syringe (not shown) with a small nozzle to inject under pressure a impression material, such as, for example, polyvinylsiloxane or polyether into the cavity 188. Preferably, this involves placing tip of the small nozzle into the internal cavity 188 through the injection port 150.

As the impression material is forced into the impression cap 178, air and excess impression material 186 is forced out of the vent holes 156. Preferably, the surgeon continues to inject impression material into the impression cap 178 until impression material extrudes from most and more preferably all of the vent holes 156. This ensures that the impression material has completely filed the internal cavity 188. As such, the impression material within the impression cap 178 will provide a precise impression of the upper region 40 of the abutment 38 without voids or tears in the impression material. The excess material that is forced into the vents 156 becomes locked or trapped within the vents 156. As mentioned above, in some embodiments, the vents 156 are funnel shaped. Advantageously, this increases the interlocking of impression cap 178 with the impression material and helps to prevent separation of the impression material from the impression cap 178.

After injecting the impression material into the impression cap 178, an impression is preferably taken of the whole arch or quadrant if the patient's mouth. This is typically involves using a U-shaped impression tray not shown that is filled with a second impression material. The tray is inserted into the mouth over the impression cap 178. As such, the impression cap 178 becomes embedded in the second impression material. The interference surface 162 of the impression cap 178 facilitates mechanically interlocking between the impression material and the impression cap 178. Such interlocking is further enhanced by the holes 156.

Once the second impression material is set, the tray is removed from the mouth. The impression cap 178 remains embedded in the second impression material and is thus uncoupled from the final abutment 38 as the tray is removed. The tray is then sent to a dental laboratory and is used by a dental technician to fabricate a final restoration (i.e., a dental prosthesis). An analog (not shown) of the abutment may be placed within the impression cap, with the same axial orientation as the abutment 38 and the implant 10 in the patient's mouth. The impression tray is then filled or covered with dental stone or any modeling material. After the modeling material has set the model is separated from the impression. The model is an accurate reproduction of the implant site and allows the dental technician to fabricate the final restoration for the patient in the proper position in axial and rotational alignment.

The stone or plaster analogue may then be used to form the final restoration (not shown), using conventional techniques that may involve using a coping and/or modifying the abutment on the stone model. In other embodiments, various commercially available productions CAD/CAM systems may also be used to scan the stone or plastic model and to guide the design and creation of the final restoration (e.g., the system marketed and used by Nobel Biocare under the trademark Procera™) (see also e.g., U.S. Pat. Nos. 6,062,861, 5,938,446, 5,880,962, 5,752,828, 5,733,126, 5,652,709, 5,587,912, 5,440,496, which are hereby incorporated by reference in their entirety herein). In other embodiments, prefabricated copings and/or final restorations may also be used.

In some instances the dental surgeon may choose to modify the shape of the upper region 40 of the abutment 38. For example, the upper region 40 may be modified to refine the occulusal length and axial draw. By way of example, the upper region 40 may be modified using a high-speed dental handpiece with carbide burs.

One advantage of the impression cap 178 is that it may be used to record the shape a modified abutment. That is, after the abutment 38 has been modified the impression cap 178 may snapped into place. The impression cap 178 is then filled as described above and an impression is taken of the patient's mouth. The impression tray is then sent to a dental laboratory. At the laboratory, the impression cap 178 is filled with dental stone or any modeling material, thereby reproducing the shape of the upper region 40 of the abutment 38, which was stored in the first impression material.

In modified embodiments, the impression cap 178 may be configured such that it does not engage the dental implant 10 with a realeasable retention force. In such embodiments, the cap 178 may be configured to rest on the shoulder 47 of the abutment. In this manner, the modified impression cap may also be used as a pick-up coping as is known in the art.

Additional embodiments and further details of the impression cap 178 can be found in co-pending U.S. patent application Ser. No. 09/945,158, filed Aug., 30 2001 and entitled “IMPRESSION CAP”, which is hereby incorporated by reference in its entirety herein.

FIGS. 5A-5E illustrate an exemplary embodiment of a coping 600 that may be used with the implant 10 described above to form a final restoration. The illustrated coping 600 is configured to mate with the abutment 38 of the implant 10 of FIG. 1A or an analogue of the abutment 38.

The illustrated coping 600 comprises a main body 602. The main body 602 includes an inner surface 604, that defines an internal cavity 606. The inner surface 604 is configured such that the coping 600 may fit over the abutment 38.

The inner surface includes one or more feet or standoffs 610. Each standoff 640 preferably extends from the inner surface 604 towards the center of the cavity 606 at least about 10 microns and often approximately 25-50 microns. The inner surface 604 preferably also includes a flanged portion 612, which is configured to rest upon shoulder 47 of the abutment 38. Preferably, the flanged portion 612 is sized and configured such that the coping 600 is centered on the abutment 38 or analogue and a top surface 614 of the inner surface 604 lies a desired distance (e.g., at least about 10 microns and often approximately 25-50 microns) above the abutment 38 or analogue.

In the illustrated arrangement, the standoffs 610 preferably extend from the top surface 615 of the inner surface 604. Moreover, the coping 600 preferably includes six standoffs 610, which are preferably arranged around the perimeter of the inner surface 604 at approximately 60 degrees from each other. This arrangement is preferred because for any angular orientation of the illustrated coping 600 with respect to the abutment 38 do not lie within the recesses or grooves 51 (see FIG. 1A). As such, at least one standoff 610 contacts the outer surface of the abutment 38. In this manner, the standoffs 610 and the flanged portion 612 cooperate to produce a substantially uniform gap between the coping 600 and the abutment 38.

FIGS. 6A-6C illustrate another arrangement of a coping 700. The illustrated coping 700 is also configured to mate with the abutment 38 of the implant 10. The illustrated coping 700 comprises a main body 702. The main body 702 includes an inner surface 704 that defines an internal cavity 706. The inner surface 704 is configured such that the coping 700 may fit over the upper region abutment 38 described above. The inner surface 704 includes one or more feet or standoffs 710. In this arrangement, the standoffs 710 are configured to fit within the grooves or recesses 51 of the abutment 38 (see FIG. 1A). As such, the standoffs 710 help to orient and prevent the rotation of the coping 700 with respect to the abutment 38. The standoffs 710 are also configured such that the inner surface 704 of the coping lies at least about 10 microns and often approximately 25-50 microns above the outer surface of the final abutment or analogue 550. That is, the standoffs 710 are configured to extend from the inner surface 604 at least and additional 10 microns and often approximately 25-50 microns beyond the depth of the grooves or recesses 51.

The inner surface 704 preferably also includes a flanged portion 712, which is configured to rest upon a lower portion or shoulder 47 of the abutment 38. Preferably, the flanged portion 712 is sized and configured such that the coping 700 is centered on the analogue and a top surface 715 of the inner surface 704 lies a desired distance (e.g., at least about 10 microns and often approximately 25-50 microns) above the abutment 38. The standoffs 710 and the flanged portion 712 cooperate to produce a uniform gap between the coping 700 and the abutment.

Several methods for creating a final restoration from the copings 600, 700 described above. One such method utilizes investment casting techniques to create a metal coping with an inner surface substantially similar to the inner surface 604, 704 of the coping 600, 700. In such a method, the coping 600 may be made of plastic or another material suitable for investment casting. The technician applies, by way of example, wax to the outer surface of the coping 600 to form a model of a metal coping. The technician removes the wax and the coping 600 from an analogue of the implant 10 and encases the combination in an investment material. The investment material is then heated to remove the wax and coping 600. The technician fills the investment material with a metal, such as, for example, gold or another suitable materials. Once the metal solidifies, the investment material is broken to release a metal coping.

The metal coping will have an inner surface that is substantially the same shape and size as the inner surface 604 of the plastic coping 600. Accordingly, the metal coping will includes standoffs that are substantially the same size as the standoffs 610 describe above. Moreover, the inner surface of the metal coping will include a top surface and a lower flange that are the same distance from each other as the top surface 615 and lower flange 612 of the plastic coping 610.

To form the final restoration, a porcelain cover or other suitable tooth-like material is attached to the metal coping using well known techniques. The metal coping provides structural strength and rigidity to the final restoration. When the final restoration is placed upon the abutment 38 of the implant 10, the standoffs and the lower flange create a uniform gap for the cement between the metal coping and the abutment 38. Moreover, the standoffs help to center the final restoration on the abutment 38. Accordingly, the final restoration rests squarely and evenly upon the final abutment 10.

In one modified embodiment, the coping is made from a material that is suitable forming at least part of the final restoration Such materials may include gold or a ceramic material. In such, an embodiment, the final restoration may be attached directly or built upon the coping.

Further details on the coping and other modified embodiments can be found in U.S. patent application Ser. No. 09/881,860, filed Jun. 15, 2001, entitled “COPINGS WITH STANDOFFS”, which is hereby incorporated by reference in its entirety herein.

FIGS. 7A and 7B illustrate a modified implant 800. This implant 800 has a lower body 812 that may be configured as described above with reference to FIGS. 1A-1D. In this embodiment, the abutment 838 comprises a sidewall 839 which tapers inwardly from the collar 816 to provide the abutment 838 with a generally conical shape with a taper of about 5 degrees. Grooves 850 preferably extend partially around a top segment 852 of the abutment 838, except for a smooth flat surface 854. The smooth surface 854 is preferably characterized by a flat plane or face intersecting and truncating the outer surface of the otherwise conical shape of the top segment 852. This flat surface 854 provides for engagement with a wrench or other torque providing tool and also provides anti-rotation relative to any mating components.

As shown in FIGS. 7A and 7B, in the illustrated embodiment, the top edge 823 of the bone apposition surface 821 may have a curved or scalloped shape with at least one and more preferably two peaks and valleys that follow or at least closely approximate the shape of the naturally occurring contours of a patient's bone-tissue morphology. It should also be appreciated that in other embodiments, the peaks and valleys may be approximated by various combinations of straight and/or curved lines that follow or at least closely approximate the shape of the naturally occurring contours of a patient's bone-tissue morphology. The surface above the top edge 823 may be smooth or polished.

The implant 800 of FIGS. 7A and 7B may be used to replace narrow, smaller diameter teeth, such as, for example, the anterior teeth and, in particular, the incisors. In such applications, the edentulous spaces are particularly narrow. Accordingly, the sidewall 839 preferably has a maximum diameter that is no greater and, more preferably smaller than the diameter of the maximum diameter of the collar 816. In one embodiment, the collar 816 has a maximum diameter of about 3.0 millimeters.

In use, the upper portion of the implant 800 may be with a healing cap. An exemplary embodiment of such a healing cap 860 is shown in FIGS. 8A-8B. The healing cap 860 is formed from body 862 having an outer surface 864 and an inner surface 866. In the illustrated embodiment, the outer surface 864 has generally vertical sidewalls 868 and a horizontal top surface 870 that is connected to the sidewalls 868 by a rounded top edge 872. The inner surface 866 forms a cavity 874. The inner surface 866 is preferably configured to substantially match in shape and size the outer surface of the abutment 838. Accordingly, the inner surface 866 includes a flat 876 that corresponds to the flat 854 formed on the abutment 838. To secure the cap 860 to the abutment 838, an adhesive may be applied to the outer surface of the abutment 838 and/or the inner surface 866 of the cap 860 before the cap 860 is inserted onto the abutment 838. After a healing period, the cap 860 may be removed from the abutment 38 with a dental pick, an impression may be taken of the patient's mouth to record the position of the implant 800, a final restoration may formed and attached to the abutment 838.

FIGS. 9A and 9B illustrate another exemplary embodiment of an implant 900. This implant 900 is a substantially similar to the previous embodiment. However, this embodiment is configured for larger diameter teeth. In one embodiment, the collar 916 has a diameter of about 4.3 millimeters.

With reference to FIGS. 9A and 9B, as compared to the previous embodiment, the distal end of the abutment 938has been removed or truncated leaving the abutment with a substantially flat top surface 950. As with the previous embodiment, the top edge 923 of the bone apposition surface 921 may have a curved or scalloped shape with at least one and more preferably two peaks and valleys that follow or at least closely approximate the shape of the naturally occurring contours of a patient's bone-tissue morphology. It should also be appreciated that in other embodiments, the peaks and valleys may be approximated by various combinations of straight and/or curved lines that follow or at least closely approximate the shape of the naturally occurring contours of a patient's bone-tissue morphology. The surface above the top edge 823 may be smooth or polished.

In use, after the implant 900 is installed into the patient's mouth, an impression may be taken of the implant 900 to record the position of the implant 900 and/or any modifications made to the shape of the abutment 938 by the dental surgeon. A final restoration may then be formed and attached to the abutment 938 with an adhesive (e.g., dental cement).

Certain objects and advantages of the invention have been described above for the purpose of summarizing the invention and the advantages achieved over the prior art. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Furthermore, although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. A dental implant system, comprising:
an dental implant including a body portion and an abutment portion, the implant body portion located at a distal end and configured to lie at least partially below a crest of a patient's jawbone, the abutment portion located at a proximate end of the implant and configured to lie at least partially above the crest of the patient's jawbone, the abutment portion comprising a flared portion, a shoulder portion and a final restoration portion, the shoulder portion lying between the flared portion and the final restoration portion; and
a healing cap including a body portion having a proximal and a distal end, the body portion defining an inner cavity which is sized and adapted so that the healing cap fits over the final restoration portion, the healing cap further including a tissue retention flange at the distal end that extends below the shoulder portion when the healing cap is coupled to the abutment portion.

2. The dental implant system of claim 1, wherein the body portion and the abutment portion of the implant are permanently attached to each other.

3. The dental implant system of claim 1, wherein the body portion and the abutment portion of the implant are machined from a single piece of material.

4. The dental implant system of claim 1, wherein the tissue retraction flange also extends away from the flared portion.

5. The dental implant system of claim 1, wherein a gap is formed between the tissue retraction flange and the flared portion.

6. The dental implant system of claim 1, wherein the body portion of the healing cap includes a base portion that is configured to rest at least partially on the shoulder portion of the abutment portion.

7. The dental implant system of claim 1, wherein the body portion includes a bone apposition surface.

8. The dental implant system of claim 1, wherein the healing cap is white.

9. The dental implant system of claim 1, wherein the healing cap has a color that is substantially the same a natural tooth.

10. The dental implant system of claim 1, wherein the abutment portion and the healing cap have round cross-sections.

11. The dental implant system of claim 1, wherein the abutment portion and the healing cap have non-round cross-sections.

12. The dental implant system of claim 1, in combination with an impression cap for taking dental impressions in a patient's mouth, the impression cap comprising a distal end that includes a top surface, a proximal end that defines an opening, and an inner surface that defines an internal cavity, the proximal end of the impression cap configured to engage the shoulder portion of the dental implant, the impression cap further comprising an injection port configured to receive a tip of an injection syringe for-injecting impression material into the inner cavity and a plurality vent holes configured to allow air and excess impression material to escape from the inner cavity.

13. The dental implant system of claim 12, wherein the proximal end of the impression cap is configured to engage the shoulder of the abutment portion in a snap fit.

14. The dental implant system of claim 12, wherein the proximal end of the impression cap includes an internal notch formed on the inner surface, the proximal notch sized and dimensioned so as to engage the corresponding shoulder of the prosthetic abutment in a snap fit.

15. The dental implant system of claim 12, further comprising one or more embedment features for facilitating the gripping and retention of the impression cap within impression material.

16. The dental implant system of claim 15, wherein the one or more embedment features comprises a shelf, which defines an interference surface that lies generally traverse to a longitudinal axis of the impression cap.

17. The dental implant system of claim 12, wherein the vent holes comprise three sets of three vent holes that are arranged vertically, each set of vent holes being spaced approximately 120 degrees apart around the perimeter of the impression cap.

18. The dental implant system of claim 1, in combination with a coping for creating a final restoration, the coping comprising a body portion having a proximal end, a distal end and an inner surface that defines an internal cavity and at least one standoff that extends from the inner surface towards a center of the internal cavity.

19. The dental implant system of claim 18, wherein the at least one standoff extends at least about 25 microns from the inner surface.

20. The dental implant system of claim 19, wherein the at least one standoff extends less than about 50 microns from the inner surface.

21. The dental implant system of claim 18, wherein the coping is made of a material that can be melted and removed from a mold during an investment casting process.

22. The dental implant system of claim 21, wherein the coping is made of plastic.

23. The dental implant system of claim 22, wherein the coping is made from a material that is suitable for forming a portion of the final restoration.

24. The dental implant system of claim 23, wherein the coping is made of gold.

25. The dental implant system of claim 23, wherein the coping is made of a ceramic material.

26. The dental implant system of claim 18, wherein the at least one standoff has a tapered shape.

27. The dental implant system of claim 18, further comprising a flanged region that configured to rest upon a shoulder of a final abutment.

28. A method for installing a prosthetic tooth, comprising the steps of:
inserting a distal end of a body portion of a single stage dental implant having a body portion and an abutment portion into a patient's jawbone during a first stage surgery;
coupling a healing cap to an abutment portion of the combination, during first stage surgery, such that a tissue retraction flange of the healing cap extends below a shoulder portion of the abutment portion,
removing the healing cap from the abutment portion during a second stage surgery,
taking an impression of the combination during the second stage surgery after the healing cap has been removed from the abutment portion.

29. A method as in claim 28, wherein the step of coupling a healing cap to an abutment portion of the combination, further includes using a healing cap screw to couple the healing cap to the abutment portion.

30. A method as in claim 28, further comprising
providing an impression cap with an injection port and a plurality of vent holes;
positioning the impression cap onto the abutment portion of the implant; and
injecting a first impression material into the impression cap through the injection port until the first impression material is extruded through at least one of the vent holes.

31. A method as in claim 30, wherein the step of positioning the impression cap onto the abutment portion includes snapping the impression cap onto the shoulder of the abutment portion.

32. A method as in claim 30, further including the steps of taking an impression of the patient's mouth by placing an impression tray filed with a second impression material over the impression cap and removing the impression tray and the impression cap from the patient's mouth.

33. A method as in claim 30, further including modifying the shape of the abutment portion.

34. A method as in claim 30, wherein the step of injecting the first impression material into the impression cap includes inserting a tip of a syringe filled with the first impression material into the injection port of the impression cap.

35. A method as in claim 28, further comprising:
providing a coping having a body portion that comprises a proximal end, a distal end and an inner surface that defines an internal cavity and at least one standoff that extends from the inner surface towards a center of the internal cavity;
providing an analogue of the abutment portion of the dental implant,
placing the coping over the analogue;
applying a material suitable for investment casting to an outer surface of the coping;
encasing the coping and the material suitable for investment casting in an investment material;
melting the coping and the material suitable for investment casting;
removing the coping and the material suitable for investment casting from the investment material; and
filling a cavity within the investment material with a material suitable for forming a part of a final restoration.
